(19) United States
(12) Patent Application Publication
(10) Pub. No.: US 2026/0051701 A1
(43) Pub. Date: Feb. 19, 2026

(54) LOCKING DEVICE

(71) Applicant: Wistron NeWeb Corporation, Hsinchu (TW)

(72) Inventors: Chung-Hau WANG, Hsinchu (TW); Ying-Chih LIU, Hsinchu (TW)

(21) Appl. No.: 19/056,885

(22) Filed: Feb. 19, 2025

(30) Foreign Application Priority Data
Aug. 16, 2024 (TW) 113130976

(51) Int. Cl. H01R 13/631

(52) U.S. Cl. CPC H01R 13/631

(57) ABSTRACT

A locking device includes a housing and a locking element. A compartment is formed inside the housing. The housing includes an elastic piece on a side thereof, and a free end of the elastic piece protrudes toward the compartment. The locking element is connected to the housing and is located on the side of the housing. The locking element is made of a temperature-sensitive deforming material. The compartment of the housing is configured for plugging a plug-in device. When the plug-in device is inserted into the compartment, the elastic piece contacts and limits the plug-in device, and a temperature-sensing portion of the locking element contacts the plug-in device. When the temperature of the plug-in device rises, a deforming portion of the locking element is deformed by heat and contacts an unlocking element of the plug-in device to lock the unlocking element.

### RELATED APPLICATIONS

This application claims the benefit of priority to Taiwan Patent Application No. 113130976, filed on Aug. 16, 2024. The entire content of the above identified application is incorporated herein by reference.

### BACKGROUND

### Technical Field

The present disclosure relates to a locking device, in particular to a locking device configured to prevent unintended removal of a plug-in device.

### Description of Related Art

With the development of smart homes, the Internet of Things (IoT), and home network architectures, the demand for faster network transmission speeds has continued to grow. Consequently, the demand for higher-speed network equipment has also increased, requiring corresponding improvements in the power of relevant computing components and transmission modules.

To achieve high-speed transmission, many plug-in devices meeting these requirements have been widely applied in various transmission scenarios. Taking the Small Form-factor Pluggable (SFP) transceiver as an example, it is used by directly inserting it into a connector until the locking block clicks into the coupling position of the connector to complete installation. To remove the SFP transceiver, the unlocking lever must be pulled to disengage the locking block from the latching position, allowing the SFP transceiver to be extracted.

However, the above unlocking mechanism may result in users unintentionally removing the plug-in device under unexpected circumstances. Thus, there is a need to design related devices or structures to prevent accidental removal.

### SUMMARY

One aspect of the present disclosure is to provide a locking device that includes a housing and a locking element. A compartment is formed inside the housing, and a side of the housing includes an elastic piece. A free end of the elastic piece protrudes toward the compartment. The locking element is connected to the housing and located on the side of the housing. The locking element is made of a temperature-sensitive deforming material. The compartment of the housing is configured for plugging a plug-in device. When the plug-in device is inserted into the compartment, the elastic piece contacts and limits the plug-in device, and a temperature-sensing portion of the locking element contacts the plug-in device. When a temperature of the plug-in device rises, a deforming portion of the locking element deforms due to heat and abuts an unlocking element of the plug-in device, thereby locking the unlocking element.

Another aspect of the present disclosure is to provide a locking device that includes a housing, a locking element, and a fixing structure. A compartment is formed inside the housing, and a side of the housing includes an elastic piece. A free end of the elastic piece protrudes toward the compartment. The locking element is located on the side of the housing and is made of a temperature-sensitive deforming material. The fixing structure is connected to the housing, and the locking element is positioned between the housing and the fixing structure. The compartment of the housing is configured for plugging a plug-in device. When the plug-in device is inserted into the compartment, the elastic piece contacts and limits the plug-in device, and a temperature-sensing portion of the locking element contacts the plug-in device. When a temperature of the plug-in device rises, a deforming portion of the locking element deforms due to heat and abuts an unlocking element of the plug-in device, thereby locking the unlocking element.

### BRIEF DESCRIPTION OF THE DRAWINGS

The present disclosure can be more fully understood by reading the following detailed description of the embodiment, with reference made to the accompanying drawings as follows:

FIG. 1 is a perspective schematic diagram of a locking device according to an embodiment of the present disclosure.

FIG. 2 is an exploded schematic diagram of the locking device in FIG. 1.

FIG. 3 is a partial enlarged schematic diagram of the elastic piece of the housing and the plug-in device in the embodiment of FIG. 1.

FIG. 4A is a partial cross-sectional schematic diagram of the locking device in FIG. 1 in an unlocked state.

FIG. 4B is a partial cross-sectional schematic diagram of the locking device in FIG. 1 in a locked state.

FIG. 5 is a schematic top diagram of the locking element and the plug-in device in the embodiment of FIG. 1.

FIG. 6 is an exploded schematic diagram of a locking device according to another embodiment of the present disclosure.

FIG. 7 is a perspective schematic diagram of the locking device in FIG. 6.

FIG. 8 is an exploded schematic diagram of a locking device according to yet another embodiment of the present disclosure.

FIG. 9 is a perspective schematic diagram of the locking device in FIG. 8.

### DETAILED DESCRIPTION

The present disclosure is more particularly described in the following embodiments that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

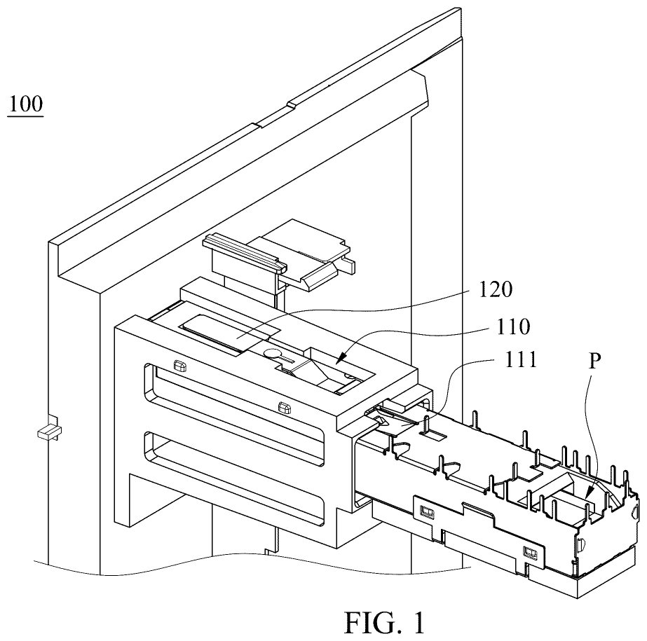

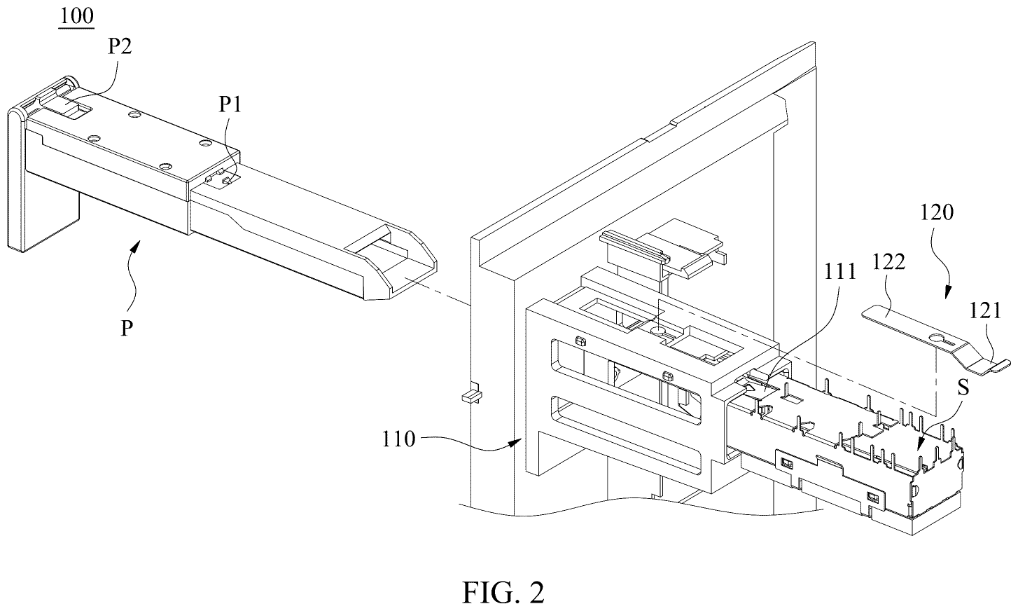

Referring to FIG. 1 and FIG. 2, FIG. 1 is a perspective schematic diagram of a locking device 100 according to an embodiment of the present disclosure, and FIG. 2 is an exploded schematic diagram of the locking device 100 in FIG. 1. The locking device 100 includes a housing 110 and a locking element 120.

Specifically, a compartment S is formed inside the housing 110 and is configured for plugging a plug-in device P. One side of the housing 110 includes an elastic piece 111, with a free end (reference is omitted) of the elastic piece 111 protruding toward the compartment S. For example, the housing 110 may generally have a rectangular prism shape, with its dimensions and detailed structure adjustable according to the plug-in device P being accommodated, and the present disclosure is not limited thereto. The elastic piece 111 of the housing 110 may be disposed on any surface of the rectangular prism, such as the surface in contact with the side of the plug-in device P. When the plug-in device P is inserted into the compartment S, the elastic piece 111 can contact and limit the plug-in device P, thereby achieving the effect of securing the plug-in device P while also providing feedback when the plug-in device P reaches its positioned state.

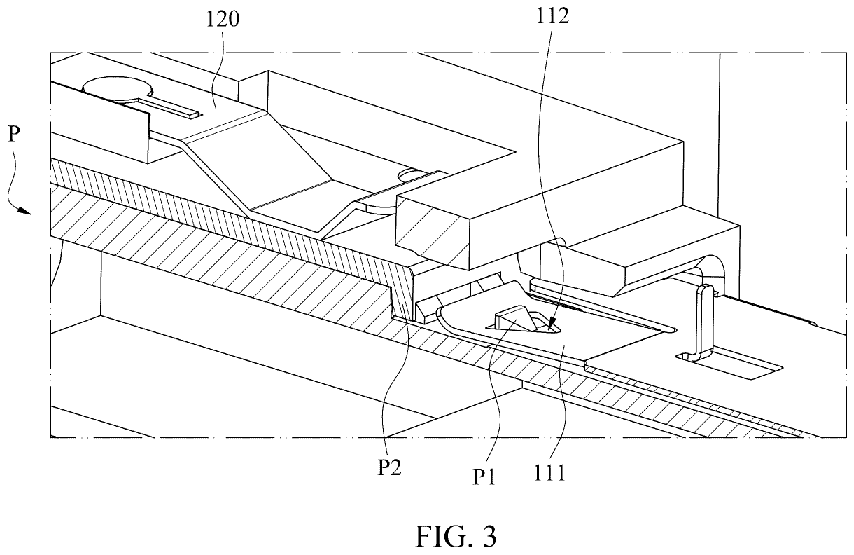

Referring to FIG. 3, FIG. 3 is a partial enlarged schematic diagram of the elastic piece 111 of the housing 110 and the plug-in device P in the embodiment of FIG. 1. The free end of the elastic piece 111 may form a curved surface, which may protrude toward the compartment S. When the plug-in device P is inserted into the compartment S, the curved surface of the elastic piece 111 may be pushed by the plug-in device P without affecting the smoothness of the insertion process. The free end of the elastic piece 111 may include a latch hole 112 configured to accommodate a locking block P1 of the plug-in device P, thereby further securing the plug-in device P.

The locking element 120 is connected to the housing 110 and located on said side of the housing 110. The locking element 120 is made of a temperature-sensitive deforming material. When the plug-in device P is inserted into the compartment S, a temperature-sensing portion 121 of the locking element 120 comes into contact with the plug-in device P. Consequently, the heat generated by the plug-in device P during operation can be conducted to the locking element 120, causing the locking element 120 to deform due to the heat and abut the plug-in device P, thereby restricting the plug-in device P from being removed.

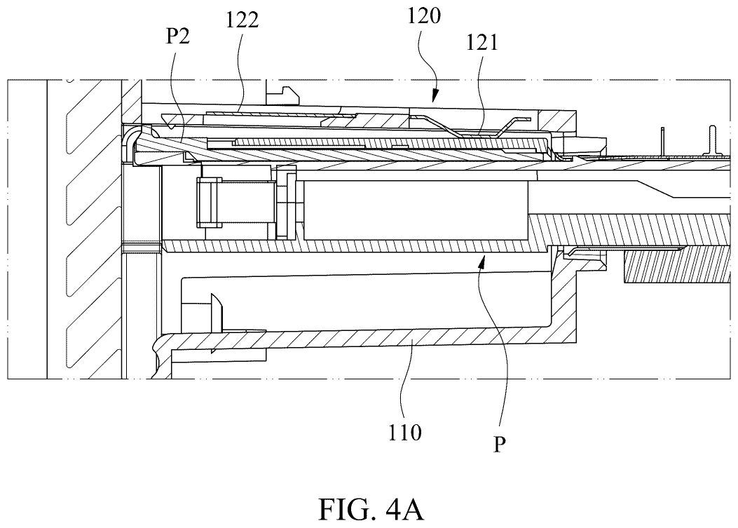

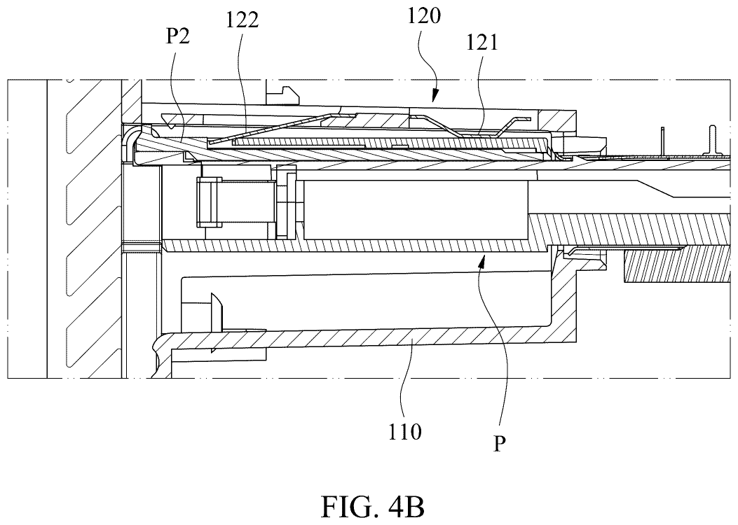

Referring to FIGS. 4A and 4B, FIG. 4A is a partial cross-sectional schematic diagram of the locking device 100 in FIG. 1 in an unlocked state, and FIG. 4B is a partial cross-sectional schematic diagram of the locking device 100 in FIG. 1 in a locked state. When the plug-in device P is inserted into the compartment S, the elastic piece 111 contacts and limits the plug-in device P, and the temperature-sensing portion 121 of the locking element 120 contacts the plug-in device P. When the temperature of the plug-in device P rises, a deforming portion 122 of the locking element 120 deforms due to heat and abuts an unlocking element P2 of the plug-in device P, preventing the unlocking element P2 from functioning to remove the plug-in device P. In this way, the unlocking element P2 is locked.

The temperature-sensing portion 121 and the deforming portion 122 of the locking element 120 may be located at opposite ends of the locking element 120. The temperature-sensing portion 121 of the locking element 120 may have a flat-top arch shape, with a flat top of the flat-top arch shape contacting the plug-in device P to achieve uniform contact and improve heat conduction efficiency. It should be noted that the temperature-sensing portion 121 of the locking element 120 only needs to contact the plug-in device P, and the deforming portion 122 only needs to block the unlocking element P2 to achieve the effect of locking the plug-in device P. Thus, the present disclosure is not limited by the positions or shapes of the temperature-sensing portion 121 and the deforming portion 122.

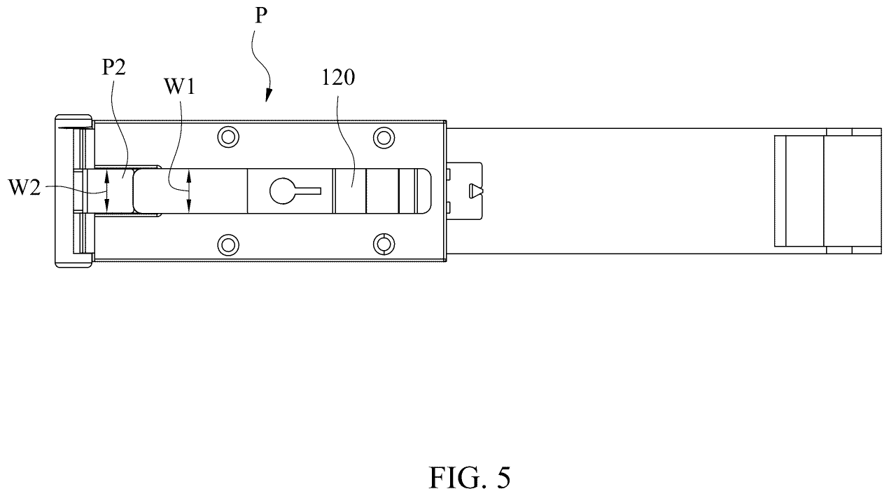

Referring to FIG. 5, FIG. 5 is a schematic top diagram of the locking element 120 and the plug-in device P in the embodiment of FIG. 1. A width W1 of the locking element 120 and a width W2 of the unlocking element P2 may have a ratio greater than or equal to 0.2, and the ratio may range from 1.0 to 1.2. This configuration enables the unlocking element P2 to be locked more securely.

Additionally, the material density on the side of the locking element 120 adjacent to the housing 110 may differ from that on the side farther from the housing 110. Alternatively, the locking element 120 may include a first layer (not shown) and a second layer (not shown). The first layer may be connected to the second layer and located closer to the housing 110 than the second layer. The thermal expansion coefficients of the first layer and the second layer may differ. When the locking element 120 is heated by the heat generated by the plug-in device P, the expansion rates on both sides of the locking element 120 differ, causing the deforming portion 122 to move toward the unlocking element P2, thereby abutting and locking the unlocking element P2. For example, the material of the first layer may be metal or ceramic, while the material of the second layer may be plastic or rubber. Alternatively, the locking element 120 may be made of manganese-nickel-copper alloy, nickel-chromium-iron alloy, nickel-manganese-iron alloy, or nickel-iron alloy. It should be noted that whether the locking element 120 is made of a single material or multiple materials, as long as it can deform in a specific direction, it falls within the protection scope of the present disclosure.

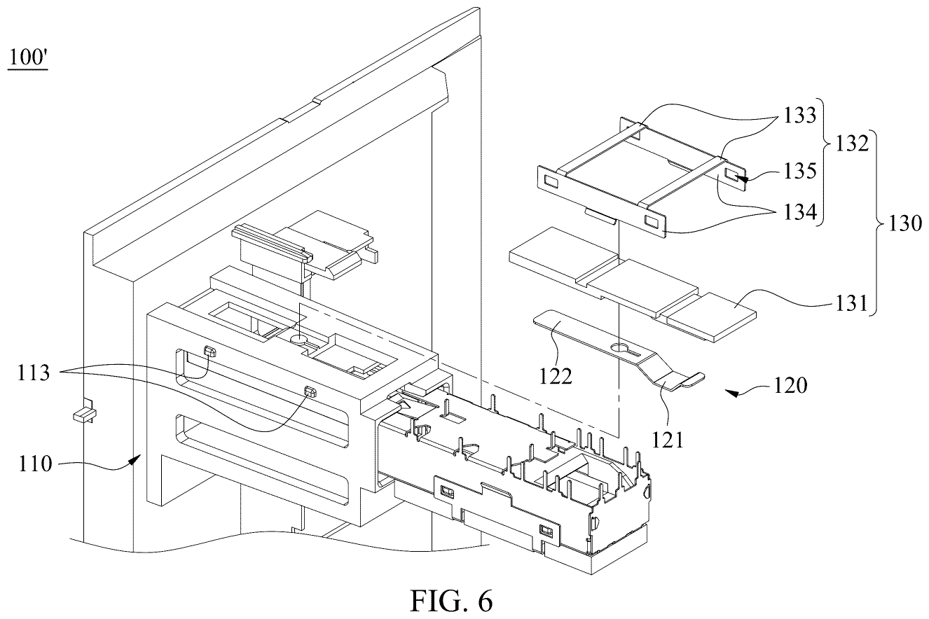

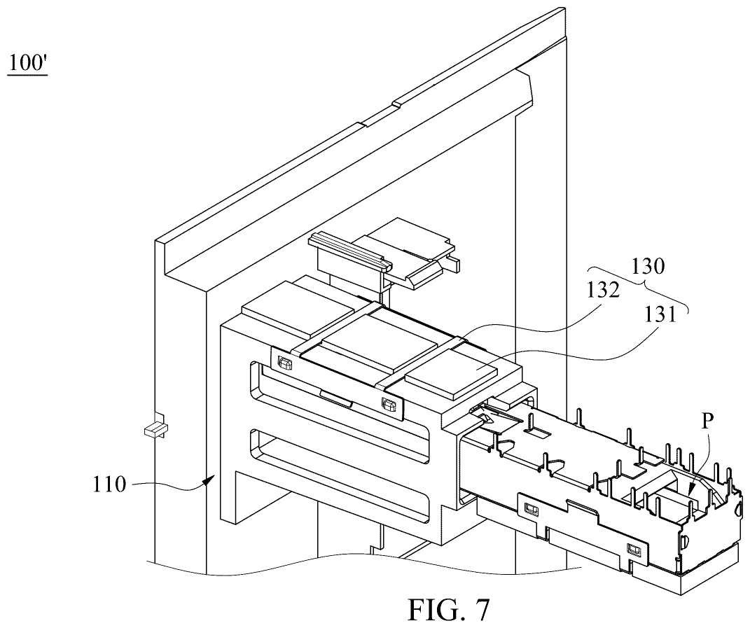

Referring to FIG. 6 and FIG. 7, FIG. 6 is an exploded schematic diagram of a locking device 100′ according to another embodiment of the present disclosure, and FIG. 7 is a perspective schematic diagram of the locking device 100′ in FIG. 6. The locking device 100′ includes a housing 110, a locking element 120, and a fixing structure 130. The detailed features of the housing 110 and the locking element 120 may be the same as those in the previous embodiment and will not be described redundantly here.

In the locking device 100′, the fixing structure 130 is connected to the housing 110, and the locking element 120 is positioned between the housing 110 and the fixing structure 130. For example, a mounting slot (reference is omitted) may be provided on the housing 110, and the locking element 120 may be placed within the mounting slot. The fixing structure 130 prevents the locking element 120 from moving or detaching from the mounting slot. It should be noted that only a portion of the locking element 120 may be positioned between the housing 110 and the fixing structure 130 to ensure that the locking element 120 can contact the plug-in device P. Additionally, the temperature-sensing portion 121 and the deforming portion 122 of the locking element 120 are not obstructed by the housing 110, thereby allowing the locking element 120 to perform temperature sensing and locking functions on the plug-in device P.

The fixing structure 130 may include a supporting element 131 and a fixing element 132. The housing 110 and the supporting element 131 can jointly clamp the locking element 120, and the fixing element 132 can connect to the housing 110 to secure the supporting element 131. Specifically, the supporting element 131 may generally have a flat plate shape and may include two grooves (reference is omitted). The fixing element 132 may have two ribs 133 and two fixing rods 134, with each rib 133 connected to the two fixing rods 134, forming an H-shaped structure as shown in FIG. 6. After installation, the two ribs 133 can engage with the two grooves to secure the position of the supporting element 131. Furthermore, the housing 110 may include multiple protrusions 113 located on opposite sides of the housing 110 near the mounting slot. The fixing rods 134 of the fixing element 132 may include multiple openings 135. After installation, the protrusions 113 can engage with the openings 135, facilitating quick installation and simplifying the assembly process.

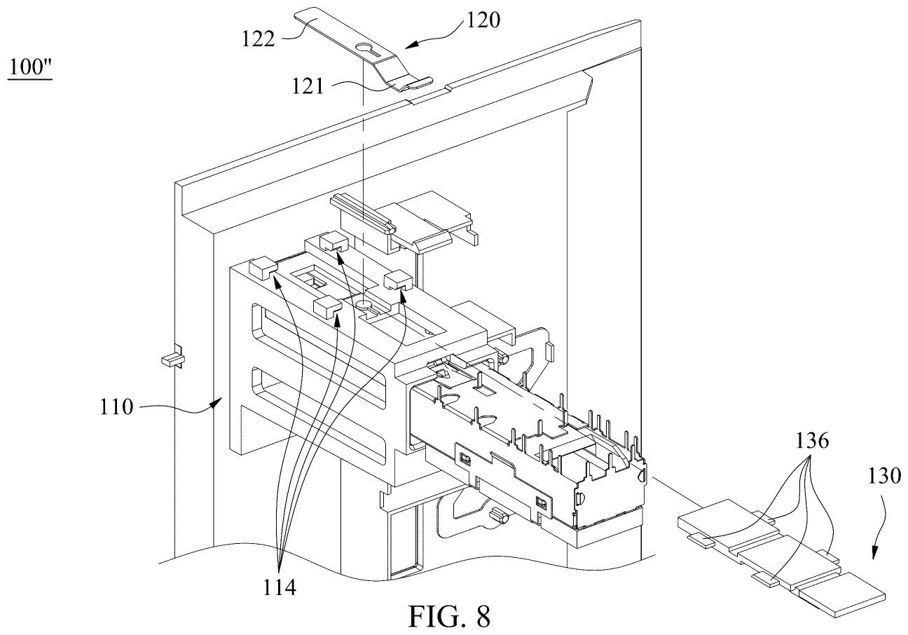

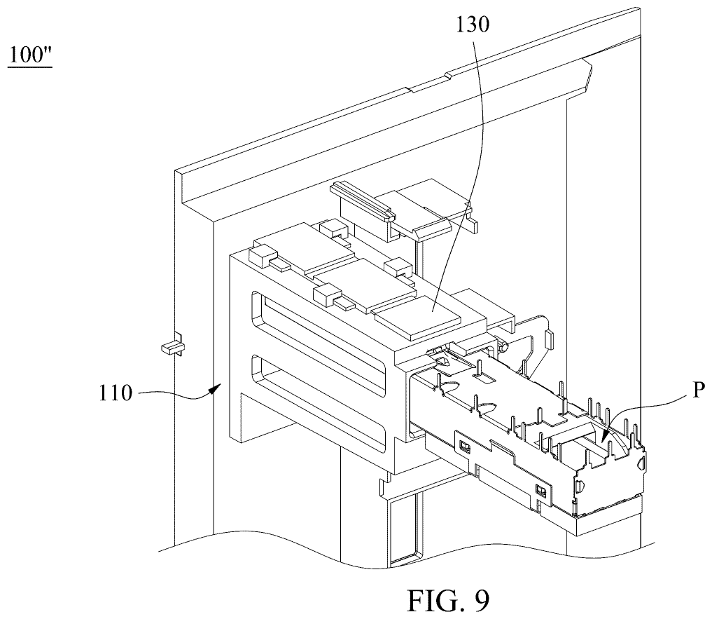

Referring to FIG. 8 and FIG. 9, FIG. 8 is an exploded schematic diagram of a locking device 100″ according to yet another embodiment of the present disclosure, and FIG. 9 is a perspective schematic diagram of the locking device 100″ in FIG. 8. The locking device 100″ includes a housing 110, a locking element 120, and a fixing structure 130. The detailed features of the housing 110 and the locking element 120 may be the same as those in the previous embodiment and will not be redundantly described here.

In the locking device 100″, the housing 110 may include at least one sliding slot 114. The sliding slot 114 may be located on a surface of the housing 110 where the mounting slot is provided and may be positioned on both sides of the mounting slot. For example, the housing 110 near the mounting slot may include multiple L-shaped locking blocks (not labeled), and the sliding slot 114 is defined by these L-shaped locking blocks. The fixing structure 130 may generally have a flat plate shape and include at least one sliding block 136. The sliding block 136 can detachably engage with the sliding slot 114. In this way, the fixing structure 130 can cover the mounting slot, allowing the housing 110 and the fixing structure 130 to jointly clamp the locking element 120. It should be noted that the present disclosure is not limited to the shapes or positions of the sliding slot 114 and the sliding block 136. As long as the sliding slot 114 and the sliding block 136 can firmly engage, they fall within the scope of the present disclosure.

Alternatively, the locking element 120 may include a through-hole (reference is omitted) positioned between the temperature-sensing portion 121 and the deforming portion 122. The fixing structure 130 may have a shape corresponding to the through-hole and may connect to the housing 110 through the through-hole. Therefore, the fixing structure 130 can engage with the through-hole via the matching shape, thereby preventing the locking element 120 from moving or wobbling while reducing material costs and manufacturing complexity.

In summary, the present disclosure employs a temperature-sensitive deforming material as the locking element. At normal temperatures, the locking element remains in an open state, allowing the unlocking element of the plug-in device to move freely, thereby releasing the locking block and removing the plug-in device. When the temperature of the plug-in device exceeds a safe threshold (e.g., 70° C.), the locking element automatically deforms, restricting the unlocking element's movement and preventing the operation of the unlocking lever, thus achieving a high-temperature locking effect. Additionally, the locking device of the present disclosure is compatible with existing plug-in devices and provides a protective function.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A locking device, comprising:
a housing, wherein a compartment is formed inside the housing, a side of the housing comprises an elastic piece, and a free end of the elastic piece protrudes toward the compartment; and
a locking element connected to the housing and located on the side of the housing, wherein the locking element is made of a temperature-sensitive deforming material;
wherein the compartment of the housing is configured for plugging a plug-in device, such that when the plug-in device is inserted into the compartment, the elastic piece contacts and limits the plug-in device, and a temperature-sensing portion of the locking element contacts the plug-in device;
wherein when a temperature of the plug-in device rises, a deforming portion of the locking element deforms due to heat and abuts an unlocking element of the plug-in device to lock the unlocking element.

2. The locking device according to claim 1, wherein the free end of the elastic piece forms a curved surface, and the curved surface protrudes toward the compartment.

3. The locking device according to claim 1, wherein the free end of the elastic piece comprises a latch hole configured to accommodate a locking block of the plug-in device.

4. The locking device according to claim 1, wherein the temperature-sensing portion and the deforming portion of the locking element are located at opposite ends of the locking element.

5. The locking device according to claim 1, wherein the temperature-sensing portion of the locking element has a flat-top arch shape, and a flat top of the flat-top arch shape contacts the plug-in device.

6. The locking device according to claim 1, wherein a ratio of a width of the locking element to a width of the unlocking element is greater than or equal to 0.2.

7. The locking device according to claim 1, wherein a material density on a side of the locking element adjacent to the housing differs from that on a side farther from the housing.

8. The locking device according to claim 1, wherein the locking element comprises a first layer and a second layer, the first layer is connected to the second layer and is located closer to the housing than the second layer, and a thermal expansion coefficient of the first layer differs from that of the second layer.

9. The locking device according to claim 8, wherein a material of the first layer is metal or ceramic, and a material of the second layer is plastic or rubber.

10. The locking device according to claim 1, wherein the locking element is made of manganese-nickel-copper alloy, nickel-chromium-iron alloy, nickel-manganese-iron alloy, or nickel-iron alloy.

11. A locking device, comprising:
a housing, wherein a compartment is formed inside the housing, a side of the housing comprises an elastic piece, and a free end of the elastic piece protrudes toward the compartment;
a locking element located on the side of the housing, wherein the locking element is made of a temperature-sensitive deforming material; and
a fixing structure connected to the housing, wherein the locking element is positioned between the housing and the fixing structure;
wherein the compartment of the housing is configured for plugging a plug-in device, such that when the plug-in device is inserted into the compartment, the elastic piece contacts and limits the plug-in device, and a temperature-sensing portion of the locking element contacts the plug-in device;
wherein when a temperature of the plug-in device rises, a deforming portion of the locking element deforms due to heat and abuts an unlocking element of the plug-in device to lock the unlocking element.

12. The locking device according to claim 11, wherein the fixing structure comprises a supporting element and a fixing element, the housing and the supporting element jointly clamp the locking element, and the fixing element connects to the housing to secure the supporting element.

13. The locking device according to claim 11, wherein the housing comprises at least one sliding slot, the fixing structure comprises at least one sliding block, the at least one sliding block detachably engages with the at least one sliding slot, and the housing and the fixing structure jointly clamp the locking element.

14. The locking device according to claim 11, wherein the locking element comprises a through-hole positioned between the temperature-sensing portion and the deforming portion, and the fixing structure connects to the housing through the through-hole.

15. The locking device according to claim 11, wherein the temperature-sensing portion of the locking element has a flat-top arch shape, and a flat top of the flat-top arch shape contacts the plug-in device.

16. The locking device according to claim 11, wherein a ratio of a width of the locking element to a width of the unlocking element is greater than or equal to 0.2.

17. The locking device according to claim 11, wherein a material density on a side of the locking element adjacent to the housing differs from that on a side farther from the housing.

18. The locking device according to claim 11, wherein the locking element comprises a first layer and a second layer, the first layer is connected to the second layer and is located closer to the housing than the second layer, and a thermal expansion coefficient of the first layer differs from that of the second layer.

19. The locking device according to claim 18, wherein a material of the first layer is metal or ceramic, and a material of the second layer is plastic or rubber.

20. The locking device according to claim 11, wherein the locking element is made of manganese-nickel-copper alloy, nickel-chromium-iron alloy, nickel-manganese-iron alloy, or nickel-iron alloy.
